(19) United States
(12) Patent Application Publication
(10) Pub. No.: US 2023/0347284 A1
(43) Pub. Date: Nov. 2, 2023

(54) SEPARATION MEMBRANE, SEPARATION MEMBRANE MANUFACTURING METHOD, AND COATING LIQUID FOR MANUFACTURING SEPARATION MEMBRANE

(71) Applicant: NITTO DENKO CORPORATION, Ibaraki-shi, Osaka (JP)

(72) Inventors: Kazuya YOSHIMURA, Ibaraki-shi, Osaka (JP); Naomichi KIMURA, Ibaraki-shi, Osaka (JP); Shinya NISHIYAMA, Ibaraki-shi, Osaka (JP)

(21) Appl. No.: 18/026,503

(22) PCT Filed: Aug. 2, 2021
(86) PCT No.: PCT/JP2021/028681

§ 371 Date: Mar. 15, 2023

(30) Foreign Application Priority Data
Sep. 17, 2020 (JP) 2020-156025

(51) Int. Cl. B01D 53/22; B01D 71/02; B01D 71/80; B01D 67/00; B01D 63/10

(52) U.S. Cl. CPC B01D 53/228; B01D 71/0211; B01D 71/80; B01D 67/0079; B01D 63/10; B01D 2257/504; B01D 2256/10; B01D 2323/06; B01D 2323/226

(57) ABSTRACT

The present invention provides a separation membrane having high separation performance in terms of a gas mixture containing an acid gas. A separation membrane 10 of the present invention includes a separation functional layer 1 including: graphene oxide; an ionic liquid; and a polymer. The ionic liquid is, for example, hydrophilic and contains an imidazolium ion and tetrafluoroborate. A method for manufacturing the separation membrane 10 of the present invention includes: applying a coating liquid containing the graphene oxide, the ionic liquid, and the polymer to a substrate to obtain a coating film; and drying the coating film.

### TECHNICAL FIELD

The present invention relates to a separation membrane, a separation membrane manufacturing method, a coating liquid for manufacturing a separation membrane.

### BACKGROUND ART

A membrane separation method has been developed as a method for separating an acid gas such as carbon dioxide from a gas mixture containing the acid gas. The membrane separation method allows an efficient separation of an acid gas with a suppressed operation cost, compared with an absorption method according to which an acid gas contained in a gas mixture is absorbed by an absorbent to be separated.

Separation membranes used in the membrane separation method include a composite membrane in which a separation functional layer is arranged on a porous support member. An intermediate layer may be disposed between the separation functional layer and the porous support member (for example, Patent Literature 1). Patent Literature 1 discloses, as a separation functional layer, a gel layer including a polymer and an ionic liquid.

### CITATION LIST

### Patent Literature

Patent Literature 1: JP 2015-160159 A

### SUMMARY OF INVENTION

### Technical Problem

Further improvement of separation performance in terms of a gas mixture containing an acid gas are required of conventional separation membranes.

Therefore, the present invention aims to provide a separation membrane having high separation performance in terms of a gas mixture containing an acid gas, particularly a gas mixture containing an acid gas and a gas having a larger molecular size than that of the acid gas.

### Solution to Problem

The present invention provides a separation membrane including a separation functional layer including: graphene oxide; an ionic liquid; and a polymer.

The present invention also provides a separation membrane manufacturing method including:
applying a coating liquid containing graphene oxide, an ionic liquid, and a polymer to a substrate to obtain a coating film; and
drying the coating film.

The present invention also provides a coating liquid being configured to be applied to a substrate to manufacture a separation membrane, the coating liquid containing:
graphene oxide;
an ionic liquid; and
a polymer.

### Advantageous Effects of Invention

The present invention can provide a separation membrane having high separation performance in terms of a gas mixture containing an acid gas, particularly a gas mixture containing an acid gas and a gas having a larger molecular size than that of the acid gas.

### BRIEF DESCRIPTION OF DRAWINGS

FIG. 1 is a cross-sectional view of a separation membrane according to an embodiment of the present invention.

FIG. 2 is a schematic cross-sectional view of a membrane separation device including the separation membrane of the present invention.

FIG. 3 is a perspective view schematically showing a modification of the membrane separation device including the separation membrane of the present invention.

FIG. 4 is a graph showing results of X-ray diffraction measurement of separation functional layers included in separation membranes of Example 1 and Comparative Example 1.

### DESCRIPTION OF EMBODIMENTS

The present invention will be described in detail below. The following description is not intended to limit the present invention to a specific embodiment.

<Embodiment of Separation Membrane>

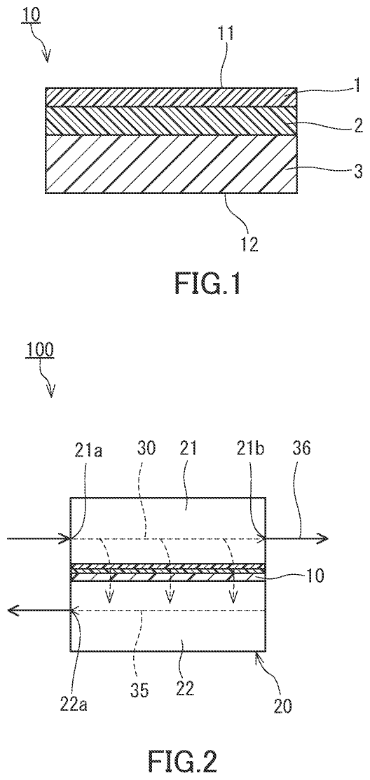

As shown in FIG. 1, a separation membrane 10 of the present embodiment includes a separation functional layer 1, and further includes, for example, an intermediate layer 2 and a porous support member 3. The porous support member 3 supports the separation functional layer 1. The intermediate layer 2 is disposed between the separation functional layer 1 and the porous support member 3, and is in direct contact with each of the separation functional layer 1 and the porous support member 3.

(Separation functional layer) The separation functional layer 1 is a layer allowing an acid gas contained in a gas mixture to preferentially permeate therethrough. The separation functional layer 1 includes graphene oxide (GO), an ionic liquid (IL), and a polymer. The ionic liquid is, for example, a salt (ionic compound) that is in a liquid state at lower than 100° C., and is typically a salt that is in a liquid state at 25° C. For example, a plurality of layers of graphene oxide are stacked in the separation functional layer 1. The ionic liquid and the polymer may be present between the layers of the graphene oxide. The graphene oxide and the polymer may be dispersed in the ionic liquid or may be present in a random fashion in the ionic liquid.

The graphene oxide included in the separation functional layer 1 is, for example, an oxide of graphene, and has a structure in which an oxygen-atom-containing functional group is introduced in graphene. Examples of the oxygen-atom-containing functional group include a hydroxy group, a carboxyl group, and an epoxy group. The graphene oxide may be reduced graphene oxide (rGO) in which a portion of the oxygen-atom-containing functional groups is reduced. The graphene oxide may include a substituent other than the oxygen-atom-containing functional group, such as a substituent including a nitrogen-atom-containing functional group (such as an amino group), but is preferably free of such a substituent. Specifically, the graphene oxide is preferably free of a substituent which is derived from the ionic liquid and which can be introduced by a reaction with the ionic liquid.

The content of the graphene oxide in the separation functional layer 1 is, for example, 0.01 wt % or more, and preferably 0.02 wt % or more from the viewpoint of improving the separation performance of the separation functional layer 1. The upper limit of the content of the graphene oxide is, for example, but not particularly limited to, 1 wt %, preferably 0.5 wt %, more preferably 0.1 wt %, and even more preferably 0.05 wt %.

The ionic liquid included in the separation functional layer 1 includes, for example, at least one selected from the group consisting of an imidazolium ion, a pyridinium ion, an ammonium ion, and a phosphonium ion, and preferably includes an imidazolium ion. These ions include, for example, a substituent having one or more carbon atoms.

Examples of the substituent having one or more carbon atoms include an alkyl group having 1 to 20 carbon atoms, a cycloalkyl group having 3 to 14 carbon atoms, and an aryl group having 6 to 20 carbon atoms, and these may be each further substituted by a hydroxy group, a cyano group, an amino group, a monovalent ether group, or the like (for example, a hydroxyalkyl group having 1 to 20 carbon atoms).

Examples of the alkyl group having 1 to 20 carbon atoms include a methyl group, an ethyl group, an n-propyl group, an n-butyl group, an n-pentyl group, an n-hexyl group, an n-heptyl group, an n-octyl group, an n-nonyl group, an n-decyl group, an n-undecyl group, an n-dodecyl group, an n-tridecyl group, an n-tetradecyl group, an n-pentadecyl group, an n-hexadecyl group, an n-heptadecyl group, an n-octadecyl group, an n-nonadecyl group, an n-eicosadecyl group, an i-propyl group, a sec-butyl group, an i-butyl group, a 1-methylbutyl group, a 1-ethylpropyl group, a 2-methylbutyl group, an i-pentyl group, a neopentyl group, a 1,2-dimethylpropyl group, a 1,1-dimethylpropyl group, a t-pentyl group, a 2-ethylhexyl group, and a 1,5-dimethylhexyl group. These may be each further substituted by a hydroxy group, a cyano group, an amino group, a monovalent ether group, or the like.

The above alkyl group may be substituted by a cycloalkyl group. The number of carbon atoms in the alkyl group substituted by the cycloalkyl group is, for example, 1 or more and 20 or less. Examples of the alkyl group substituted by the cycloalkyl group include a cyclopropyl methyl group, a cyclobutyl methyl group, a cyclohexyl methyl group, and a cyclohexyl propyl group. These may be each further substituted by a hydroxy group, a cyano group, an amino group, a monovalent ether group, or the like.

Examples of the cycloalkyl group having 3 to 14 carbon atoms include a cyclopropyl group, a cyclobutyl group, a cyclopentyl group, a cyclohexyl group, a cycloheptyl group, a cyclooctyl group, a cyclododecyl group, a norbornyl group, a bornyl group, and an adamantyl group. These may be each further substituted by a hydroxy group, a cyano group, an amino group, a monovalent ether group, or the like.

Examples of the aryl group having 6 to 20 carbon atoms include a phenyl group, a toluyl group, a xylyl group, a mesityl group, an anisyl group, a naphthyl group, and a benzyl group. These may be each further substituted by a hydroxy group, a cyano group, an amino group, a monovalent ether group, or the like.

In the present embodiment, the ionic liquid preferably contains an imidazolium ion represented by the following formula (1).

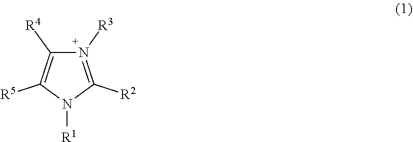

In the formula (1), R¹ to R⁵ are each independently a hydrogen atom or the above substituent having one or more carbon atoms. R¹ is preferably a substituent having one or more carbon atoms, more preferably an alkyl group having 1 to 20 carbon atoms, even more preferably an alkyl group having 3 to 10 carbon atoms, and particularly preferably an n-butyl group. R³ is preferably a substituent having one or more carbon atoms, more preferably an alkyl group having 1 to 20 carbon atoms, even more preferably an alkyl group having 1 to 10 carbon atoms, and particularly preferably a methyl group. R², R⁴, and R⁵ are each preferably a hydrogen atom.

In the ionic liquid, the above ion may form a salt with a counter anion. Examples of the counter anion include alkyl sulfate, tosylate, methanesulfonate, trifluoromethanesulfonate, toluenesulfonate, acetate, bis(fluorosulfonyl)imide, bis(trifluoromethanesulfonyl)imide, thiocyanate, dicyanamide, tricyanomethanide, tetracyanoborate, hexafluorophosphate, tetrafluoroborate, and halide. The counter anion is preferably tetrafluoroborate. That is, for example, the ionic liquid preferably includes tetrafluoroborate.

Specific examples of the ionic liquid include 1-ethyl-3-methylimidazolium bis(fluorosulfonyl)imide, 1-ethyl-3-methylimidazolium dicyanamide, 1-butyl-3-methylimidazolium bromide, 1-butyl-3-methylimidazolium chloride, 1-butyl-3-methylimidazolium tetrafluoroborate, 1-butyl-3-methylimidazolium hexafluorophosphate, 1-butyl-3-methylimidazolium trifluoromethanesulfonate, 1-butyl-3-methylimidazolium tetrachloroferrate, 1-butyl-3-methylimidazolium iodide, 1-butyl-2,3-dimethylimidazolium chloride, 1-butyl-2,3-dimethylimidazolium hexafluorophosphate, 1-butyl-2,3-dimethylimidazolium tetrafluoroborate, 1-butyl-3-methylimidazolium bis(trifluoromethanesulfonyl)imide, 1-butyl-2,3-dimethylimidazolium bis(trifluoromethanesulfonyl)imide, 1-butyl-3-methylimidazolium trifluoro(trifluoromethyl)borate, 1-butyl-3-methylimidazolium tribromide, 1,3-dimesitylimidazolium chloride, 1,3-bis(2,6-diisopropylphenyl)imidazolium chloride, 1,3-diisopropylimidazolium tetrafluoroborate, 1,3-di-tert-butylimidazolium tetrafluoroborate, 1,3-dicyclohexylimidazolium tetrafluoroborate, 1,3-dicyclohexylimidazolium chloride, 1,2-dimethyl-3-propylimidazolium iodide, 1-hexyl-3-methylimidazolium chloride, 1-hexyl-3-methylimidazolium hexafluorophosphate, 1-hexyl-3-methylimidazolium tetrafluoroborate, 1-hexyl-3-methylimidazolium bromide, 1-methyl-3-propylimidazolium iodide, 1-methyl-3-n-octylimidazolium bromide, 1-methyl-3-n-octylimidazolium chloride, 1-methyl-3-n-octylimidazolium hexafluorophosphate, 1-methyl-3-[6-(methylsulfinyl)hexyl]imidazolium p-toluenesulfonate, 1-ethyl-3-methylimidazolium tricyanomethanide, 1-ethyl-3-methylimidazolium tetracyanoborate, and 1-(2-hydroxyethyl)-3-methylimidazolium bis(trifluoromethanesulfonyl)imide.

The ionic liquid is particularly preferably 1-butyl-3-methylimidazolium tetrafluoroborate ([BMIM][BF₄]). [BMIM][BF₄] is particularly suitable for production of the separation functional layer 1.

It is preferable that the ionic liquid be substantially not reactive with the graphene oxide. Furthermore, it is preferable that the ionic liquid be hydrophilic from the viewpoint of easy production of the separation functional layer 1. Herein, that an ionic liquid is hydrophilic means that when Tests 1 and 2 below are performed, the ionic liquid dissolves in water in Test 1, while the ionic liquid does not dissolve in isopropyl alcohol (IPA) and phase separation is confirmed in Test 2.

Test 1: At room temperature (25° C.), 0.5 g of an ionic liquid is added into a container such as a micro tube, into which 0.5 g of water (ion-exchange water) is further added. Subsequently, the container is hermetically sealed, and is shaken by hand about 10 times. The container is allowed to stand still for one minute, and then whether the ionic liquid is dissolved in the water in the container is visually checked.

Test 2: At room temperature, 0.5 g of an ionic liquid is added into a container such as a micro tube, into which 0.5 g of isopropyl alcohol is further added. Subsequently, the container is hermetically sealed, and is shaken by hand about 10 times. The container is allowed to stand still for one minute, and then whether the ionic liquid is dissolved in the isopropyl alcohol in the container is visually checked.

Herein, in the case where an ionic liquid does not dissolve in water and phase separation is confirmed in Test 1, the ionic liquid is judged hydrophobic. Furthermore, in the case where an ionic liquid dissolves in water in Test 1 and the ionic liquid dissolves in isopropyl alcohol in Test 2, the ionic liquid is judged amphiphilic.

The ionic liquid preferably has a high viscosity from the viewpoint of easy production of the separation functional layer 1. The viscosity of the ionic liquid at 25° C. is, for example, 0.20 Pa·s or more, and is preferably 0.30 Pa·s or more. The upper limit of the viscosity of the ionic liquid at 25° C. is not particularly limited, and is, for example, 0.50 Pa·s. The viscosity of the ionic liquid can be measured under the following conditions using a commercially-available viscosity-viscoelastic analyzer (e.g., RheoStress RS600 manufactured by Thermo HAAKE).
Cone: C60/Ti
Measurement temperature: 25° C. (room temperature)
Shear rate γ (dγ/dt): 1 [1/s]
Rotational speed: 30 [s]

A content of the ionic liquid in the separation functional layer 1 may be higher than the content of the graphene oxide and the content of the polymer, and is, for example, 50 wt % or more, preferably 60 wt % or more, more preferably 70 wt % or more, even more preferably 80 wt % or more, and particularly preferably 90 wt % or more. The higher the content of the ionic liquid is, the more likely the separation functional layer 1 is to be able to allow an acid gas contained in a gas mixture to preferentially permeate therethrough. The upper limit of the content of the ionic liquid is not particularly limited, and is, for example, 95 wt %.

The polymer included in the separation functional layer 1 is preferably hydrophilic from the viewpoint of easy production of the separation functional layer 1. Herein, that the polymer is hydrophilic means that a distance Ra between Hansen solubility parameters of the polymer and Hansen solubility parameters of H₂O is less than 19 MPa^{1/2}. It should be noted that the distance Ra may be 19 MPa^{1/2} or more depending on the composition of the separation functional layer 1, the composition of the intermediate layer 2, a use for the separation membrane 10, etc.

The Hansen solubility parameters are parameters obtained by dividing a solubility parameter introduced by Hildebrand into three components of a dispersion term δD, a polar term δP, and a hydrogen bonding term δH. The details of the Hansen solubility parameters are disclosed in “Hansen Solubility Parameters: A Users Handbook” (CRC Press, 2007). The Hansen solubility parameters can be calculated, for example, using known software such as HSPiP.

The distance Ra between the Hansen solubility parameters of the polymer and the Hansen solubility parameters of H₂O can be calculated by the following formula (i). In the formula (i), δD₁, δP₁, and δH₁ are respectively a dispersion term (MPa^{1/2}), a polar term (MPa^{1/2}), and a hydrogen bonding term (MPa^{1/2}) of the polymer. Symbols δD₂, δP₂, and δH₂ are respectively a dispersion term (18.1 MPa^{1/2}), a polar term (17.1 MPa^{1/2}), and a hydrogen bonding term (16.9 MPa^{1/2}) of H₂O.

Ra={4×(δD₁−δD₂)²+(δP₁−δP₂)²+(δH₁−δH₂)²}^{1/2} (i)

The distance Ra between the Hansen solubility parameters of the polymer and the Hansen solubility parameters of H₂O is preferably 18 MPa^{1/2} or less, more preferably 17 MPa^{1/2} or less, even more preferably 16 MPa^{1/2} or less, and particularly preferably 15 MPa^{1/2} or less. The lower limit of the distance Ra is preferably 5 MPa^{1/2} and more preferably 8 MPa^{1/2}, and may be, in some cases, 10 MPa^{1/2} or 13 MPa^{1/2}.

The polymer has, for example, a polar group. The polar group includes, for example, at least one selected from the group consisting of a hydroxy group, an ether group, and an amide group, and preferably includes an amide group. The polymer having such a polar group tends to be hydrophilic. Specific examples of the polymer include a polyether block amide, polyvinyl alcohol (PVA), polyvinylpyrrolidone (PVP), polyacrylamide (PAA), polyhydroxyethylmethacrylate (PHEMA), and their derivatives. The separation functional layer 1 preferably includes a polyether block amide as the polymer.

The polyether block amide is a block copolymer including a polyether block PE and a polyamide block PA. The polyether block amide is represented, for example, by the following formula (2).

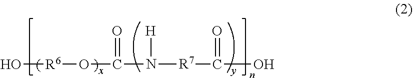

In the formula (2), R⁶ is a divalent hydrocarbon group having 1 to 15 carbon atoms. The number of carbon atoms in the divalent hydrocarbon group represented by R⁶ may be 1 to 10 or 1 to 5. The divalent hydrocarbon group represented by R⁶ is preferably a linear or branched alkylene group. Specific examples of R⁶ include an ethylene group and a butane-1,4-diyl group. R⁷ is a divalent hydrocarbon group having 1 to 20 carbon atoms. The number of carbon atoms in the divalent hydrocarbon group represented by R⁷ may be 3 to 18 or 3 to 15. The number of carbon atoms in the divalent hydrocarbon group represented by R⁷ may be a linear or branched alkylene group. Specific examples of R⁷ include a pentane-1,5-diyl group and an undecane-1,11-diyl group.

In the formula (2), a ratio (x:y) between x and y is, for example, 1:9 to 9:1, preferably 5:5 to 9:1, and more preferably 6:4 to 8:2. The symbol n is an integer of one or greater.

Specific examples of the polyether block amide include Pebax (registered trademark) 2533 and 1657 manufactured by Arkema S.A. The distance Ra between Hansen solubility parameters of Pebax 2533 and the Hansen solubility parameters of H₂O is 16.5 MPa^{1/2}. The distance Ra between Hansen solubility parameters of Pebax 1657 and the Hansen solubility parameters of H₂O is 12.4 MPa^{1/2}.

The polymer preferably is compatible with each of the graphene oxide and the ionic liquid. That is, it is preferable that in the separation functional layer 1 and a coating liquid for producing the separation functional layer 1, the polymer be substantially not separated from and fully mixed with the graphene oxide and the ionic liquid.

The content of the polymer in the separation functional layer 1 is, for example, 1 wt % or more, preferably 3 wt % or more, and more preferably 5 wt % or more. The upper limit of the content of the polymer is, for example, but not particularly limited to, 10 wt %.

The thickness of the separation functional layer 1 is, for example, 50 μm or less, preferably 25 μm or less, and more preferably 15 μm or less. In some cases, the thickness of the separation functional layer 1 may be 10 μm or less, 5.0 μm or less, or 2.0 μm or less. The thickness of the separation functional layer 1 may be 0.05 μm or more, or 0.1 μm or more.

(Intermediate Layer)

The intermediate layer 2 includes, for example, a resin, and may further include nanoparticles dispersed in the resin (matrix). The nanoparticles may be spaced from each other in the matrix, or may aggregate partially. The material of the matrix is not particularly limited, and examples thereof include a silicone resin such as polydimethylsiloxane; a fluorine resin such as polytetrafluoroethylene; an epoxy resin such as polyethylene oxide; a polyimide resin; a polysulfone resin; a polyacetylene resin such as polytrimethylsilylpropyne and polydiphenylacetylene; and a polyolefin resin such as polymethylpentene. The matrix preferably includes a silicone resin.

The nanoparticle may include an inorganic material. The nanoparticle may include an organic material. The inorganic material included in the nanoparticle is, for example, silica, titania, or alumina. The nanoparticle preferably includes silica.

The nanoparticle may have a surface modified with a modifying group including a carbon atom. The nanoparticle having the surface modified with the modifying group exhibits an excellent dispersibility in the matrix. The nanoparticle is, for example, a silica nanoparticle that may have a surface modified with a modifying group. The modifying group further includes a silicon atom, for example. The surface of the nanoparticle is represented, for example, by the following formulae (I) to (III), the surface being modified with the modifying group.

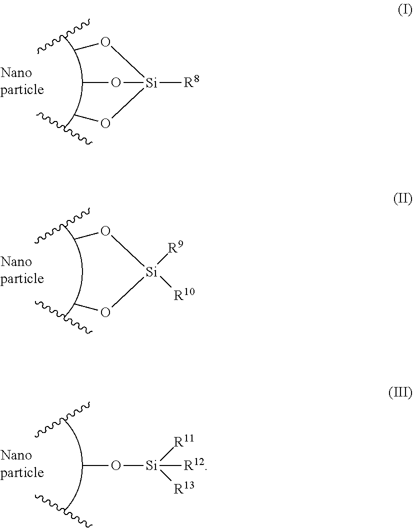

R⁸ to R¹³ in the formulae (I) to (III) are each independently an optionally substituted hydrocarbon group. The number of carbon atoms in the hydrocarbon group is not particularly limited as long as it is one or more. The number of carbon atoms in the hydrocarbon group may be, for example, 25 or less, 20 or less, 10 or less, or 5 or less. In some cases, the number of carbon atoms in the hydrocarbon group may be more than 25. The hydrocarbon group may be a linear or branched chain hydrocarbon group, or may be an alicyclic or aromatic cyclic hydrocarbon group. In a preferred embodiment, the hydrocarbon group is a linear or branched alkyl group having 1 to 8 carbon atoms. The hydrocarbon group is, for example, a methyl group or an octyl group, and is preferably a methyl group. The substituent in the hydrocarbon group is, for example, an amino group or an acyloxy group. The acyloxy group is, for example, a (meth)acryloyloxy group.

In another preferred embodiment, the above optionally substituted hydrocarbon group represented by R⁸ to R¹³ in the formulae (I) to (III) is represented by the following formula (IV). The nanoparticle having a surface modified with a modifying group including the hydrocarbon group represented by the formula (IV) is suitable for improving a permeation rate of an acid gas permeating through the separation membrane 10.

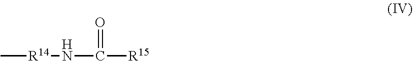

In the formula (IV), R¹⁴ is an optionally substituted alkylene group having 1 to 5 carbon atoms. The alkylene group may be linear or branched. The alkylene group is, for example, a methylene group, an ethylene group, a propane-1,3-diyl group, a butane-1,4-diyl group, or a pentane-1,5-diyl group, and is preferably a propane-1,3-diyl group. The substituent in the alkylene group is an amide group, an aminoalkylene group, or the like.

In the formula (IV), R¹⁵ is an optionally substituted alkyl group or aryl group having 1 to 20 carbon atoms. The alkyl group may be linear or branched. Examples of the alkyl group and the aryl group include those described above for the ionic liquid. Examples of the substituents in the alkyl group and the aryl group include an amino group and a carboxyl group. R¹⁵ is, for example, a 3,5-diaminophenyl group.

The surface of the nanoparticle is preferably represented by the following formula (V), the surface being modified with the modifying group.

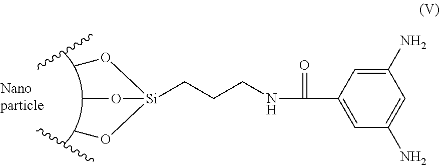

The modifying group is not limited to have the structures shown in the formulae (I) to (III). The modifying group may include a polymer chain having a polyamide structure or a polydimethylsiloxane structure instead of R⁸ to R¹³ in the formulae (I) to (III). In the modifying group, for example, this polymer chain is directly bonded to a silicon atom. Examples of the shape of this polymer chain include linear, dendritic, and hyper-branched shapes.

The method for modifying the surface of the nanoparticle with the modifying group is not particularly limited. For example, the surface of the nanoparticle can be modified by reacting a hydroxyl group present on the surface of the nanoparticle with a known silane coupling agent. In the case where the modifying group includes a polyamide structure, the surface of the nanoparticle can be modified by, for example, the method disclosed in JP 2010-222228 A.

The average particle size of the nanoparticles is not particularly limited as long as it is on the order of nanometers (<1000 nm). The average particle size of the nanoparticles is, for example, 100 nm or less, preferably 50 nm or less, and more preferably 20 nm or less. The lower limit of the average particle size of the nanoparticles is, for example, 1 nm. The average particle size of the nanoparticles can be specified by the following method, for example. First, a cross section of the intermediate layer 2 is observed with a transmission electron microscope. In the obtained electron microscope image, the area of a specific nanoparticle is calculated by image processing. The diameter of a circle having the same area as the calculated area is regarded as the particle size (the diameter of the particle) of the specific nanoparticle. The particle size is calculated for any number (at least 50) of the nanoparticles, and the average of the calculated values is regarded as the average particle size of the nanoparticles. The shape of each nanoparticle is not particularly limited, and may be a spherical, ellipsoidal, flaky, or fibrous shape.

The content of the nanoparticles in the intermediate layer 2 is, for example, 5 wt % or more, preferably 10 wt % or more, and more preferably 15 wt % or more. The upper limit of the content of the nanoparticles in the intermediate layer 2 is not particularly limited, and is, for example, 30 wt %.

The thickness of the intermediate layer 2 is not particularly limited, and is, for example, less than 50 μm, preferably 40 μm or less, and more preferably 30 μm or less. The lower limit of the thickness of the intermediate layer 2 is not particularly limited, and is, for example, 1 μm. The intermediate layer 2, for example, a layer having a thickness of less than 50 μm.

(Porous Support Member)

The porous support member 3 supports the separation functional layer 1 with the intermediate layer 2 interposed therebetween. Examples of the porous support member 3 include: a nonwoven fabric; porous polytetrafluoroethylene; an aromatic polyamide fiber; a porous metal; a sintered metal; a porous ceramic; a porous polyester; porous nylon; an activated carbon fiber; latex; silicone; silicone rubber; a permeable (porous) polymer including at least one selected from the group consisting of polyvinyl fluoride, polyvinylidene fluoride, polyurethane, polypropylene, polyethylene, polystyrene, polycarbonate, polysulfone, polyether ether ketone, polyacrylonitrile, polyimide, and polyphenylene oxide; a metallic foam having an open cell or a closed cell; a polymer foam having an open cell or a closed cell; silica; a porous glass; and a mesh screen. The porous support member 3 may be a combination of two or more of these materials.

The porous support member 3 has, for example, an average pore diameter of 0.01 to 0.4 μm. The thickness of the porous support member 3 is not particularly limited, and, for example, 10 μm or more, preferably 20 μm or more, and more preferably 50 μm or more. The thickness of the porous support member 3, for example, 300 μm or less, preferably 200 μm or less, and more preferably 150 μm or less.

(Separation Membrane Manufacturing Method)

The separation membrane 10 can be produced by the following method, for example. First, a coating liquid containing the graphene oxide, the ionic liquid, and the polymer is prepared. The coating liquid may further contain a solvent such as water or an organic solvent. The coating liquid may be subjected to sonication or stirring beforehand.

The coating liquid preferably has a high viscosity from the viewpoint of easy production of the separation functional layer 1. With the coating liquid having a high viscosity, a coating film is likely to be formed efficiently. The coating liquid has a viscosity of, for example, 0.15 Pa·s or more, and preferably 0.20 Pa·s or more at 25° C. The upper limit of the viscosity of the coating liquid at 25° C. is not particularly limited, and is, for example, 0.50 Pa·s. The viscosity of the coating liquid can be measured according to the method and conditions described above for the ionic liquid.

Next, this coating liquid is applied to a substrate to obtain a coating film. The method for applying the coating liquid is not particularly limited, and the spin coating method can be used, for example. The thickness of the separation functional layer 1 formed of the coating film can be adjusted by adjusting the rotational speed of a spin coater, the solid content concentration in the coating liquid, etc.

The substrate to which the coating liquid is applied is typically a laminate of the porous support member 3 and the intermediate layer 2. This laminate can be produced by the following method, for example. First, a coating liquid containing the materials of the intermediate layer 2 is prepared. Next, the coating liquid containing the materials of the intermediate layer 2 is applied onto the porous support member 3 to form a coating film. The method for applying the coating liquid is not particularly limited, and a dip coating method can be used, for example. The coating liquid may be applied, for example, using a wire bar. Next, the coating film is dried to form the intermediate layer 2. The coating film can be dried under heating conditions, for example. The heating temperature of the coating film is, for example, 50° C. or higher. The heating time of the coating film is, for example, one minute or longer, and may be five minutes or longer. Furthermore, the surface of the intermediate layer 2 may be subjected to an adhesion improvement treatment, if necessary. The adhesion improvement treatment is, for example, a surface treatment such as application of a primer, a corona discharge treatment, or a plasma treatment.

When the substrate is the laminate of the porous support member 3 and the intermediate layer 2, the separation functional layer 1 is formed by drying the coating film formed on the substrate, and the separation membrane 10 is obtained thereby. The drying conditions for the coating film can be the same as the conditions described above for the intermediate layer 2.

The substrate is not limited to the laminate of the porous support member 3 and the intermediate layer 2, and may be a transfer film. When the substrate is a transfer film, the separation membrane 10 can be produced by the following method. First, the separation functional layer 1 is formed by drying a coating film formed on the substrate. Next, the coating liquid containing the materials of the intermediate layer 2 is applied onto the separation functional layer 1, and the applied coating liquid is dried to form the intermediate layer 2. The laminate of the intermediate layer 2 and the separation functional layer 1 is transferred to the porous support member 3. The separation membrane 10 is obtained in this manner.

(Properties of Separation Membrane)

In the separation membrane 10 of the present embodiment, the separation functional layer 1 includes the graphene oxide, the ionic liquid, and the polymer. The ionic liquid is likely to improve the permeation rate of an acid gas permeating through the separation membrane 10. Additionally, in combination with the ionic liquid and the polymer, the graphene oxide is likely to be able to reduce permeation of a gas having a relatively large molecular size through the separation functional layer 1. As described above, since the separation functional layer 1 includes the graphene oxide, the ionic liquid, and the polymer, the separation membrane 10 is likely to have high separation performance in terms of a gas mixture containing an acid gas, particularly a gas mixture containing an acid gas and a gas having a larger molecular size than that of the acid gas.

The gas mixture containing an acid gas and a gas having a larger molecular size than that of the acid gas is, for example, a gas mixture containing carbon dioxide (molecular size: 0.33 nm) and nitrogen (molecular size: 0.364 nm). In other words, the separation membrane 10 is suitable for use in separating carbon dioxide from a gas mixture containing carbon dioxide and nitrogen. The gas mixture containing carbon dioxide and nitrogen is, for example, an off-gas from a chemical plant or a thermal power plant.

In one example, a separation factor α of the separation membrane 10 for carbon dioxide with respect to nitrogen is, for example, 70 or more, preferably 80 or more, and more preferably 90 or more. The upper limit of the separation factor α is, for example, but not particularly limited to, 200.

The separation factor α can be measured by the following method. First, to a space adjacent to one surface (for example, a principal surface 11 of the separation membrane 10 on the separation functional layer side) of the separation membrane 10, a gas mixture composed of carbon dioxide and nitrogen is supplied. As a result, in a space adjacent to the other surface (for example, a principal surface 12 of the separation membrane 10 on the porous support member side) of the separation membrane 10, a permeated fluid that has permeated through the separation membrane 10 is obtained. The weight of the permeated fluid and the volume rate of carbon dioxide and the volume rate of nitrogen in the permeated fluid are measured. In the above operation, the concentration of the carbon dioxide in the gas mixture is 50 vol % under standard conditions (0° C., 101 kPa). The gas mixture supplied to the space adjacent to the one surface of the separation membrane 10 has a temperature of 30° C. and a pressure of 0.1 MPa. The separation factor α can be calculated by the following formula. It should be noted that, in the following formula, X_{A} and X_{B} are respectively the volume rate of the carbon dioxide and the volume rate of the nitrogen in the gas mixture. Y_{A} and Y_{B} are respectively the volume rate of the carbon dioxide and the volume rate of the nitrogen in the permeated fluid that has permeated through the separation membrane 10.

Separation factor α=(Y_{A}/Y_{B})/(X_{A}/X_{B})

Under the above conditions for measuring the separation factor α, a permeation rate T of carbon dioxide permeating through the separation membrane 10 is, for example, 50 GPU or more and preferably 100 GPU or more. The upper limit of the permeation rate T is, for example, but not particularly limited to, 500 GPU, and may be 350 GPU. Here, GPU means 10⁻⁶·cm³ (STP)/(sec·cm²·cmHg). The symbol cm³ (STP) means the volume of carbon dioxide at 1 atmospheric pressure and 0° C.

(Embodiment of Membrane Separation Device)

As shown in FIG. 2, a membrane separation device 100 of the present embodiment includes the separation membrane 10 and a tank 20. The tank 20 includes a first chamber 21 and a second chamber 22. The separation membrane 10 is disposed in the tank 20. In the tank 20, the separation membrane 10 separates the first chamber 21 and the second chamber 22 from each other. The separation membrane 10 extends from one of a pair of wall surfaces of the tank 20 to the other.

The first chamber 21 has an inlet 21a and an outlet 21b. The second chamber 22 has an outlet 22a. The inlet 21a, the outlet 21b, and the outlet 22a are each, for example, an opening provided in a wall surface of the tank 20.

Membrane separation using the membrane separation device 100 is performed by the following method, for example. First, a gas mixture 30 containing an acid gas is supplied to the first chamber 21 via the inlet 21a. The acid gas in the gas mixture 30 is, for example, carbon dioxide, hydrogen sulfide, carbonyl sulfide, sulfur oxide (SOx), hydrogen cyanide, and nitrogen oxide (NOx), and is preferably carbon dioxide. The gas mixture 30 contains a gas other than the acid gas. The other gas is, for example, a nonpolar gas such as hydrogen or nitrogen or an inert gas such as helium, and is preferably nitrogen. The concentration of the acid gas in the gas mixture 30 is not particularly limited, and is, for example, 0.01 vol % (100 ppm) or more, preferably 1 vol % or more, more preferably 10 vol % or more, still more preferably 30 vol % or more, and particularly preferably 50 vol % or more, under standard conditions. The upper limit of the concentration of the acid gas in the gas mixture 30 is, for example, but not particularly limited to, 90 vol % under standard conditions.

The pressure in the first chamber 21 may be increased by supplying the gas mixture 30. The membrane separation device 100 may further include a pump (not shown) for increasing the pressure of the gas mixture 30. The pressure of the gas mixture 30 to be supplied to the first chamber 21 is, for example, 0.1 MPa or more, and preferably 0.3 MPa or more.

The pressure in the second chamber 22 may be decreased while the gas mixture 30 is supplied to the first chamber 21. The membrane separation device 100 may further include a pump (not shown) for decreasing the pressure in the second chamber 22. The pressure in the second chamber 22 may be decreased such that a space in the second chamber 22 has a pressure lower than an atmospheric pressure in a measurement environment by, for example, 10 kPa or more, preferably 50 kPa or more, and more preferably 100 kPa or more.

Supply of the gas mixture 30 to the first chamber 21 allows to obtain, on the other surface side of the separation membrane 10, a permeated fluid 35 in which the acid gas content is higher than in the gas mixture 30. That is, the permeated fluid 35 is supplied to the second chamber 22. The permeated fluid 35 contains, for example, the acid gas as a main component. The permeated fluid 35 may contain a small amount of a gas other than the acid gas. The permeated fluid 35 is discharged outside the tank 20 via the outlet 22a.

The concentration of the acid gas in the gas mixture 30 gradually increases from the inlet 21a toward the outlet 21b in the first chamber 21. The gas mixture 30 (a concentrated fluid 36) processed in the first chamber 21 is discharged outside the tank 20 via the outlet 21b.

The membrane separation device 100 of the present embodiment is suitable for flow (continuous) membrane separation. The membrane separation device 100 of the present embodiment may be used for batch membrane separation.

(Modification of Membrane Separation Device)

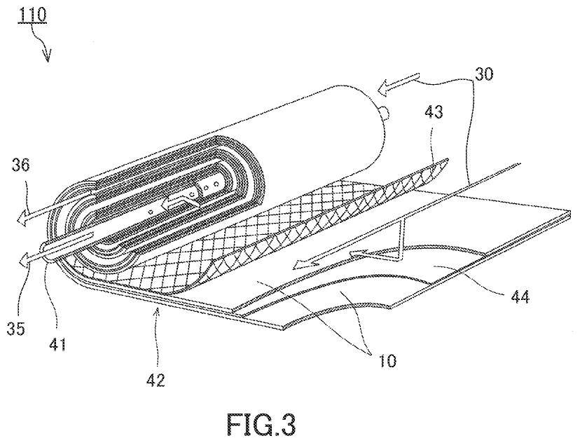

As shown in FIG. 3, a membrane separation device 110 of the present embodiment includes a central tube 41 and a laminate 42. The laminate 42 includes the separation membrane 10. The membrane separation device 110 is a spiral membrane element.

The central tube 41 has a cylindrical shape. The central tube 41 has, in its surface, a plurality of holes for allowing the permeated fluid 35 to flow into the central tube 41. Examples of the material of the central tube 41 include: resins such as an acrylonitrile-butadiene-styrene copolymer resin (ABS resin), a polyphenylene ether resin (PPE resin), and a polysulfone resin (PSF resin); and metals such as stainless steel and titanium. The central tube 41 has an inner diameter in the range of 20 to 100 mm for example.

The laminate 42 further includes a supply-side flow passage material 43 and a permeation-side flow passage material 44 in addition to the separation membrane 10. The laminate 42 is wound around the central tube 41. The membrane separation device 110 may further include an exterior material (not shown).

For example, a resin net composed of polyphenylene sulfide (PPS) or an ethylene-chlorotrifluoroethylene copolymer (ECTFE) can be used as the supply-side flow passage material 43 and the permeation-side flow passage material 44.

Membrane separation using the membrane separation device 110 is performed by the following method, for example. First, the gas mixture 30 is supplied into one end of the wound laminate 42. The permeated fluid 35 that has permeated through the separation membrane 10 of the laminate 42 moves into the central tube 41. The permeated fluid 35 is discharged outside via the center tube 41. The gas mixture 30 (concentrated fluid 36) processed by the membrane separation device 110 is discharged outside from the other end of the wound laminate 42. Thus, the acid gas can be separated from the gas mixture 30.

### EXAMPLES

Hereinafter, the present invention will be described in more detail by way of example and comparative examples. However, the present invention is not limited to this example.

[Characteristics of Ionic Liquids]

First, 33 types of commercially-available ionic liquids were subjected to Tests 1 and 2 described above to evaluate the solubility of each ionic liquid in water and isopropyl alcohol. Table 1 shows the results. Table 1 shows cation-anion pairs forming the ionic liquids and characteristics of the ionic liquids formed of the respective pairs. For example, according to Table 1, 1-butyl-3-methylimidazolium tetrafluoroborate ([BMIM][BF₄]) is hydrophilic. In Table 1, criteria for evaluation of the characteristics of the ionic liquids are as follows.
Hydrophilic: The ionic liquid dissolves in water in Test 1 and the ionic liquid does not dissolve in isopropyl alcohol in Test 2.
Hydrophobic: The ionic liquid does not dissolve in water in Test 1.
Amphiphilic: The ionic liquid dissolves in water in Test 1 and the ionic liquid dissolves in isopropyl alcohol in Test 2.

TABLE 1

| | | [FSI] | [TFSI] | [BF₄] | [PF₆] | [FEP] | [CI] | [SCN] | [N(CN)₂] |
|---|---|---|---|---|---|---|---|---|---|
| Imidazolium- | [EMIM] | Hydro- | Hydro- | Amphi- | — | Hydro- | — | Amphi- | Amphi- |
| based | | phobic | phobic | philic | | phobic | | philic | philic |
| | [BMIM] | — | Hydro- | Hydro- | — | — | — | Amphi- | Amphi- |
| | | | phobic | philic | | | | philic | philic |
| | 1-(2- | — | — | — | — | — | — | — | Amphi- |
| | Hydroxyethyl)- | | | | | | | | philic |
| | 3-methyl- | | | | | | | | |
| | imidazolium | | | | | | | | |
| | 1-Allyl-3- | — | — | — | — | — | — | — | Amphi- |
| | methyl- | | | | | | | | philic |
| | imidazolium | | | | | | | | |
| | [HMIM] | — | Hydro- | — | Hydro- | Hydro- | — | — | — |
| | | | phobic | | phobic | phobic | | | |
| | [OMIM] | — | Hydro- | — | Hydro- | — | — | — | — |
| | | | phobic | | phobic | | | | |
| Ammonium- | N_{1,4,4,4} | — | Hydro- | — | — | — | — | — | — |
| based | | | phobic | | | | | | |
| | N_{1,8,8,8} | — | Hydro- | — | — | — | — | — | — |
| | | | phobic | | | | | | |
| Phosphonium- | P_{4,4,4,12} | — | Hydro- | — | — | — | — | — | — |
| based | | | phobic | | | | | | |
| | P_{6,6,6,14} | — | Hydro- | — | — | — | Hydro- | — | Hydro- |
| | | | phobic | | | | phobic | | phobic |
| Pyridine- | OMPrid | Hydro- | — | — | — | — | — | — | — |
| based | | phobic | | | | | | | |

| | | | | | | L-(+)- |
|---|---|---|---|---|---|---|
| | | [C(CN)₃] | [B(CN)₄] | [Acetate] | [CF₃COO] | lactate |
| Imidazolium- | [EMIM] | Amphi- | Hydro- | Amphi- | Amphi- | Amphi- |
| based | | philic | phobic | philic | philic | philic |
| | [BMIM] | Hydro- | — | Amphi- | Amphi- | — |
| | | phobic | | philic | philic | |
| | 1-(2- | — | — | — | — | — |
| | Hydroxyethyl)- | | | | | |
| | 3-methyl- | | | | | |
| | imidazolium | | | | | |
| | 1-Allyl-3- | — | — | — | — | — |
| | methyl- | | | | | |
| | imidazolium | | | | | |
| | [HMIM] | — | Hydro- | — | — | — |
| | | | phobic | | | |
| | [OMIM] | — | — | — | — | — |
| Ammonium- | N_{1,4,4,4} | — | — | — | — | — |
| based | N_{1,8,8,8} | — | — | — | — | — |
| Phosphonium- | P_{4,4,4,12} | — | — | — | — | — |
| based | P_{6,6,6,14} | — | — | — | — | — |
| Pyridine- | OMPrid | — | — | — | — | — |
| based | | | | | | |

Abbreviations shown in Table 1 are as follows.
[EMIM]: 1-Ethyl-3-methylimidazolium
[BMIM]: 1-Butyl-3-methylimidazolium
[HMIM]: 1-Hexyl-3-methylimidazolium
[OMIM]: 1-Octyl-3-methylimidazolium
N_{1,4,4,4}: N-Methyl-N,N,N-tributylammonium
N_{1,8,8,8}: N-Methyl-N,N,N-trioctylammonium
P_{4,4,4,12}: Tributyldodecylphosphonium
P_{6,6,6,14}: Trihexyltetradecylphosphonium
[FSI]: Bis(fluorosulfonyl)imide
[TFSI]: Bis(trifluoromethanesulfonyl)imide
[FEP]: Tris(pentafluoroethyl)trifluorophosphate

As understood from Table 1, an ionic liquid containing a cation having an alkyl group having a relatively large number of carbon atoms and an ionic liquid containing an anion (e.g., [FSI], [TFSI], and [FEP]) having a fluorine atom and having a relatively large molecular size tend to be hydrophobic.

### Example 1

First, a dispersion containing polydimethylsiloxane was prepared, and the dispersion was applied onto a porous support member. Polysulfone (PSF) was used as a material of the porous support member. The dispersion was applied by dip coating. Next, the resulting coating film was heated at 120° C. for 2 minutes to be dried, thereby a laminate of the porous support member and an intermediate layer was produced. The surface of the intermediate layer was subjected to a corona discharge treatment.

Next, a dispersion A in which the content of a polyether block amide (Pebax manufactured by Arkema S.A.) was 5 wt %, a dispersion B in which the content of the graphene oxide was 0.4 wt %, and an ionic liquid were mixed to obtain a mixture. The dispersion A contained isopropyl alcohol and water (weight ratio: 70:30) in addition to the polyether block amide. The dispersion B contained water in addition to the graphene oxide. As the ionic liquid was used 1-butyl-3-methylimidazolium tetrafluoroborate ([BMIM][BF₄]). The obtained mixture was subjected to sonication for 1 hour and then stirring for 30 minutes to prepare a coating liquid. The viscosity of the coating liquid at 25° C. was 0.20 Pa·s.

Next, the coating liquid was applied onto the intermediate layer of the above laminate. The dispersion was applied by spin coating. A spin coater was rotated at a rotational speed of 2000 rpm for 1 minute. Subsequently, the resulting coating film was heated at 100° C. for 15 minutes to be dried, thereby a separation functional layer was produced. The separation functional layer had a thickness of approximately 3 μm. The content of the polyether block amide was 7.83 wt %, the content of the graphene oxide was 0.050 wt %, and the content of the ionic liquid was 92.12 wt % in the separation functional layer. A separation membrane of Example 1 was obtained in this manner.

### Comparative Examples 1 to 3

Separation membranes of Comparative Examples 1 to 3 were obtained in the same manner as in Example 1, except that the type of the ionic liquid, the presence/absence of the graphene oxide, and the presence/absence of the polyether block amide were changed as shown in Table 2.

[Evaluation of Properties of Separation Membrane]

Next, the separation factor α (CO₂/N₂) for carbon dioxide with respect to nitrogen and the permeation rate T of carbon dioxide were evaluated by the following method for the separation membranes of Example and Comparative Examples. First, each separation membrane was placed in a metal cell, and the metal cell was sealed with an O-ring so that no leakage would occur. Next, a gas mixture was injected into the metal cell so that the gas mixture would come into contact with the principal surface of the separation membrane on the separation functional layer side. The gas mixture was composed substantially of carbon dioxide and nitrogen. The concentration of carbon dioxide in the gas mixture was 50 vol % under standard conditions. The temperature of the gas mixture injected into the metal cell was 30° C. The pressure of the gas mixture was 0.1 MPa. Accordingly, a permeated fluid was obtained from the principal surface of the separation membrane on the porous support member side. The separation factor α and the permeation rate T of carbon dioxide were calculated based on the composition of the obtained permeated fluid, the weight of the permeated fluid, etc. Table 2 shows the results.

TABLE 2

| | | | | | Viscosity | | |
|---|---|---|---|---|---|---|---|
| | | | | Polyether | of coating | Selectivity | CO₂ |
| | Ionic liquid | | Graphene | block | liquid | α CO₂/N₂ | permeation |
| | Type | Characteristic | oxide | amide | [Pa · s] | [—] | rate [GPU] |
| Example 1 | [BMIM][BF₄] | Hydrophilic | Present | Present | 0.20 | 99.5 | 130 |
| Comparative | [BMIM][BF₄] | Hydrophilic | Absent | Present | — | 67.4 | 97.4 |
| Example 1 | | | | | | | |
| Comparative | [EMIM][TFSI] | Hydrophobic | Absent | Present | — | 34.4 | 394 |
| Example 2 | | | | | | | |
| Comparative | [BMIM][BF₄] | Hydrophilic | Present | Absent | — | 50.7 | 5.2 |
| Example 3 | | | | | | | |

It is understood from Table 2 that the separation membrane of Example 1 including the separation functional layer including the graphene oxide, the ionic liquid, and the polymer has a higher separation factor α for carbon dioxide with respect to nitrogen than those of the separation membranes of Comparative Examples and has high separation performance in terms of a gas mixture containing an acid gas.

[X-Ray Diffraction Measurement]

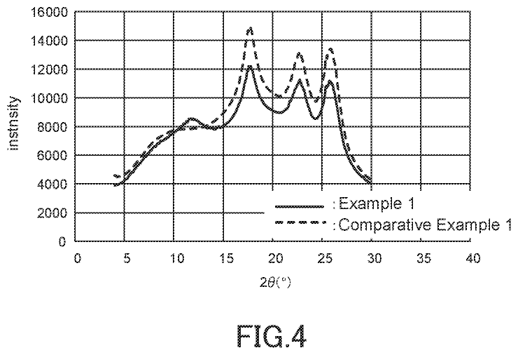

Next, the separation functional layers of Example 1 and Comparative Example 1 were each subjected to X-ray diffraction (XRD) measurement. FIG. 4 shows the results. Comparison between Example 1 and Comparative Example 1 reveals that a peak attributed to the graphene oxide is at a diffraction angle 2θ=11.77° in Example 1. This result reveals that in the separation functional layer of Example 1, a plurality of layers of graphene oxide are stacked and an interlayer distance in the graphene oxide is 0.751 nm. In the graphene oxide, an oxygen-atom-containing functional group tends to extend in a direction (laminate direction) perpendicular to a plane direction of the graphene oxide. Given that the length of a C—O bond is approximately 0.191 nm, the shortest distance between two graphene oxide layers adjacent to each other in the laminate direction is approximately 0.369 nm in Example 1, which is nearly equal to the molecular size (0.364 nm) of nitrogen. From this fact, it is inferred that in Example 1, it was difficult for a nitrogen molecule to pass through an interval between two graphene oxide layers adjacent to each other in the laminate direction and therefore permeation of a nitrogen molecule through the separation functional layer was reduced.

### INDUSTRIAL APPLICABILITY

The separation membrane of the present embodiment is suitable for separating an acid gas from a gas mixture containing the acid gas. In particular, the separation membrane of the present embodiment is suitable for separating carbon dioxide from an off-gas from a chemical plant or a thermal power plant.

1. A separation membrane comprising a separation functional layer including: graphene oxide; an ionic liquid; and a polymer.

2. The separation membrane according to claim 1, wherein the ionic liquid is hydrophilic.

3. The separation membrane according to claim 1, wherein the ionic liquid contains an imidazolium ion.

4. The separation membrane according to claim 1, wherein the ionic liquid contains tetrafluoroborate.

5. The separation membrane according to claim 1, wherein a content of the ionic liquid in the separation functional layer is 50 wt % or more.

6. The separation membrane according to claim 1, wherein the polymer is compatible with each of the graphene oxide and the ionic liquid.

7. The separation membrane according to claim 1, wherein the polymer has a polar group.

8. The separation membrane according to claim 7, wherein the polar group includes at least one selected from the group consisting of a hydroxy group, an ether group, and an amide group.

9. The separation membrane according to claim 1, wherein the polymer includes a polyether block amide.

10. The separation membrane according to claim 1, further comprising a porous support member supporting the separation functional layer.

11. The separation membrane according to claim 10, further comprising an intermediate layer disposed between the separation functional layer and the porous support member.

12. The separation membrane according to claim 1, being for use in separating carbon dioxide from a gas mixture containing carbon dioxide and nitrogen.

13. A separation membrane manufacturing method comprising:
applying a coating liquid containing graphene oxide, an ionic liquid, and a polymer to a substrate to obtain a coating film; and
drying the coating film.

14. The manufacturing method according to claim 13, wherein the coating liquid has a viscosity of 0.15 Pa·s or more at 25° C.

15. A coating liquid being configured to be applied to a substrate to manufacture a separation membrane, the coating liquid comprising:
graphene oxide;
an ionic liquid; and
a polymer.

16. The coating liquid according to claim 15, having a viscosity of 0.15 Pa·s or more at 25° C.
